(19) United States
(12) Patent Application Publication
(10) Pub. No.: US 2006/0120571 A1
(43) Pub. Date: Jun. 8, 2006

(54) System and method for passive face recognition

(76) Inventors: Peter Henry Tu, Schenectady, NY (US); Timothy Patrick Kelliher, Scotia, NY (US); Jens Rittscher, Schenectady, NY (US); Nils Oliver Krahnstoever, Schenectady, NY (US)

Correspondence Address: Patrick S. Yoder;FLETCHER YODER, P.O. Box 692289, Houston, TX, 77269-2289, US

(21) Appl. No.: 11/003,229

(22) Filed: Dec. 3, 2004

(51) Int. Cl. G06K 9/00

(52) U.S. Cl. 382/118

(57) ABSTRACT

A system and method of face recognition is provided. The method includes capturing an image including a face and registering features of the image to fit with a model face to generate a registered model face. The registered model face is then transformed to a desired orientation to generate a transformed model face. The transformed model face is then compared against a plurality of stored images to identify a number of likely candidates for the face. In addition, the face recognition process may be performed passively.

### BACKGROUND

The invention relates generally to biometric systems, and more particularly to a system and method for biometric authentication via face recognition.

Biometrics may be defined as measurable physiological or behavioral characteristics of an individual useful in verifying or authenticating an identity of the individual for a particular application. Biometrics is increasingly being used as a security tool and authentication tool for industrial and commercial activities, such as credit card transactions, network firewalls, or perimeter security. For example, applications include authentication at restricted entries or secure systems on the Internet, hospitals, banks, government facilities, airports, and so forth.

Existing biometric authentication techniques include fingerprint verification, hand geometry measurement, voice recognition, retinal scanning, iris scanning, signature verification, and facial recognition. Unfortunately, these authentication techniques have a variety of limitations, inaccuracies, and so forth. For example, existing fingerprint verification systems may not recognize a valid fingerprint if dirt, oils, cuts, blood, or other impurities are disposed on the finger and/or the reader. By further example, hand geometry verification systems generally require a large scanner, which may not be feasible for some applications. Implementation of voice recognition is difficult because of variants such as environmental acoustics, microphone quality, and temperament of the individual. Furthermore, voice recognition systems have difficult and time-consuming training processes, while also requiring large space for template storage. One drawback with retinal scanning is that the individual must look directly into the retinal reader. It is also inconvenient for an individual having eyeglasses, because the individual must remove their eyeglasses for a retinal scan. Another problem associated with retinal scanning is that the individual must focus at a given point for performing the scan. Failure to focus correctly reduces the accuracy of the scan. While signature verification has proved to be relatively accurate, it is obtrusive for the individual. Regarding facial recognition systems, existing authentication techniques have primarily focused on matching two static images of the individual. Unfortunately, these facial recognition systems are relatively inconsistent and inaccurate due to variances in the facial pose or angle relative to the camera.

In addition to the various drawbacks noted above, all of these existing biometric authentication techniques require an individual to actively engage the particular system, thereby making the existing authentication systems inconvenient, time consuming, and effective only for restricted points of entry or passage. In other words, existing authentication systems are unworkable for passive monitoring or delocalized security checks, because the individual could simply walk by the authentication device. Without a means for capturing the necessary fingerprint, hand configuration (e.g., all fingers spread out and palm down), retinal scan, verbal phrase (e.g., “my name is John Smith”), signature, or facial pose (e.g., front and center), these authentication systems will be unable to perform their function.

In certain applications, it may be desirable to have passive monitoring and delocalized security checks, because these functions may detect unauthorized activities that would not otherwise be detectable by an authentication system at a point of entry or passage. For example, if an individual does not consent to being authenticated at a point of entry or passage, then the individual may simply bypass the localized authentication system and subsequently act as they desire.

Therefore, there is a need for a system and method that can passively identify individuals for purposes of monitoring, security, and so forth.

### SUMMARY

According to one aspect of the present technique, a system and method of face recognition is provided. The method includes capturing an image including a face and registering features of the image to fit with a model face to generate a registered model face. The registered model face is then transformed to a desired orientation to generate a transformed model face. The transformed model face is then compared against a plurality of stored images to identify a number of likely candidates for the face. In addition, the face recognition process may be performed passively.

In accordance with another aspect of the present technique, a surveillance system for identifying a person is provided. The system includes one or more imaging devices, each of which is operable to capture at least one image of the person including a face to generate a captured image. A face registration module included in the system fits the captured image to a model face to generate a registered model face. A face transformation module transforms the registered model face into a transformed model face with a desired orientation. A face recognition module identifies at least one likely candidate from a plurality of stored images based on the transformed model face. The imaging devices may capture the images even without any active cooperation from the person.

In accordance with another aspect of the present technique, a method of providing security is provided. The method includes providing imaging devices in a plurality of areas through which individuals pass. The imaging devices obtain facial images of each of the individuals. The method further includes providing a face recognition system, which recognizes an individual having the facial images by iteratively and cumulatively identifying candidates for each of the facial images.

These and other advantages and features will be more readily understood from the following detailed description of preferred embodiments of the invention that is provided with the accompanying drawings.

### BRIEF DESCRIPTION OF THE DRAWINGS

FIG. 1 is a diagrammatic representation of an exemplary facility including cameras at multiple locations for facial authentication in accordance with aspects of the present technique;

FIG. 2 is a diagrammatic representation of an area within the facility of FIG. 1, illustrating a camera capturing images of an individual at multiple locations and multiple poses for facial authentication in accordance with aspects of the present technique;

FIG. 3 is a diagrammatic representation of an exemplary face recognition system in accordance with aspects of the present technique;

FIG. 4 is a flow chart illustrating a face authentication process of the exemplary face recognition system illustrated in FIG. 3 in accordance with one aspect of the present technique;

FIG. 5 is a flow chart illustrating a face registration process of the face authentication process in FIG. 4 in accordance with one aspect of the present technique;

FIG. 6 is a diagrammatic representation of different face registration stages of the face registration process in FIG. 5 in accordance with one aspect of the present technique; and

FIG. 7 is a diagrammatic representation of an exemplary face transformation process of the face authentication process in FIG. 4 in accordance with one aspect of the present technique.

### DETAILED DESCRIPTION OF EXEMPLARY EMBODIMENTS

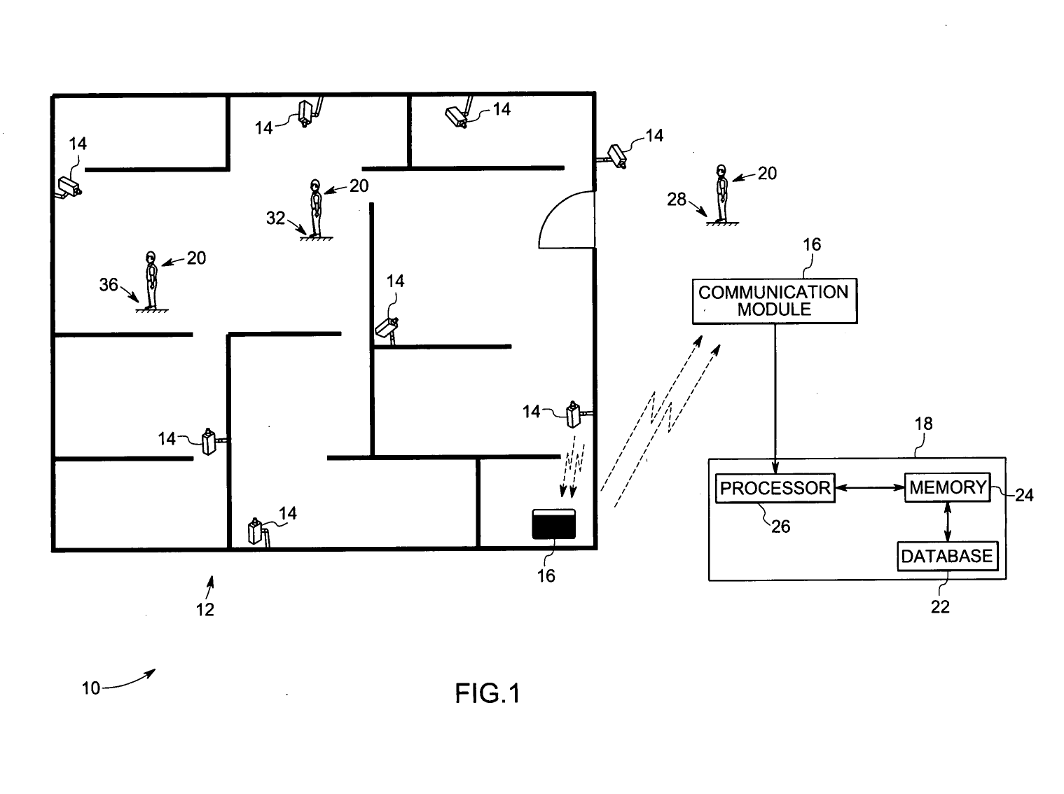

Referring generally to FIG. 1, this figure is a diagrammatic view illustrating a passive facial recognition system 10 in accordance with embodiments of the present technique. As discussed in detail below, an embodiment of the system 10 monitors individuals, tracks their movement, passively acquires facial images (e.g., without requiring their consent or participation), transforms the acquired facial images into a desired orientation (e.g., camera focal point, facial pose, etc.), identifies a number of likely candidates based on the transformed images, and repeats the process to reduce the likely candidates to one individual. In other words, the system 10 iteratively and cumulatively identifies candidates that could have each of the facial images and culls from these candidates a single candidate with a desired certainty. In the illustrated embodiment, the passive facial recognition system 10 is configured to monitor a facility 12, which has a plurality of imaging devices 14 located at various locations in the facility 12. The imaging devices 14 may include video devices, such as still cameras or video cameras. The facility 12 may be a secure location, such as an airport, a bank, an automatic teller machine (ATM) center, a secure defense establishment, a border patrol area, a residential location, a commercial complex, a hospital, etc. The imaging devices 14 may include a network of still or video cameras or a closed circuit television (CCTV) network.

The illustrated facial recognition system 10 also includes one or more communication modules 16 disposed in the facility 12, and optionally at a remote location, to transmit still images or video signals to a monitoring unit 18. As discussed in further detail below, the monitoring unit 18 processes the still images or video signals to perform face recognition of individuals 20 traveling about different locations within the facility 12. In certain embodiments of the facial recognition system 10, the communication modules 16 include wired or wireless networks, which communicatively link the imaging devices 14 to the monitoring unit 18. For example, the communication modules 16 may operate via telephone lines, cable lines, Ethernet lines, optical lines, satellite communications, radio frequency (RF) communications, and so forth. Moreover, embodiments of the monitoring unit 18 may be disposed locally at the facility 12 or remotely at another facility, such as a security monitoring company or station.

The monitoring unit 18 includes a variety of software and hardware for performing facial recognition of individuals 20 entering and traveling about the facility 12. For example, the monitoring unit 18 can include file servers, application servers, web servers, disk servers, database servers, transaction servers, telnet servers, proxy servers, mail servers, list servers, groupware servers, File Transfer Protocol (FTP) servers, fax servers, audio/video servers, LAN servers, DNS servers, firewalls, and so forth. As shown in FIG. 1, the monitoring unit 18 includes one or more databases 22, memory 24, and one or more processors 26. The memory 24 can include hard disk drives, optical drives, tape drives, random access memory (RAM), read-only memory (ROM), programmable read-only memory (PROM), Redundant Arrays of Independent Disks (RAID), flash memory, magneto-optical memory, holographic memory, bubble memory, magnetic drum, memory stick, Mylar® tape, smartdisk, thin film memory, zip drive, and so forth. Embodiments of the databases 22 use the memory 24 to store facial images of the individuals 20, information about individuals 20, rights and restrictions for the individuals 20, facial registration code, facial transformation code, facial recognition code, one or more model faces, and other data or code to carry out facial recognition of the individuals 20. When an individual 20 is enrolled into the facial recognition system 10, a complete model face is formed and stored in the database 22 for that individual 20. For example, the model face may be a three-dimensional model of the face of the individual 20. Moreover, the databases 22 use the memory 24 to store images or video streams that are acquired as individuals 20 pass by the various imaging devices 14 within the facility 12. This creates the database of individuals in the system 10.

In operation, each imaging device 14 may acquire a series of facial images, e.g., at different poses or facial angles, as the individual 20 approaches, leaves, or generally passes by the respective imaging device 14. Advantageously, these facial images are acquired passively or, in other words, without any active participation from the individual 20. In turn, the one or more processors 26 process the acquired facial images, register the acquired facial images to an appropriate model face, transform the acquired/registered facial images to a desired pose (e.g., a front pose), and perform facial recognition on the acquired/registered/transformed facial images to identify one or more likely individuals stored in the database 22. The foregoing process may be repeated for a series of facial images, such that each iteration narrows the list of likely individuals from all the images stored in the database 22. In one embodiment, each facial image acquired by the camera 14 may capture a different portion, angle, or pose of the individual 20, such that iterative processing of these facial images produces a cumulatively more accurate facial recognition of that particular individual 20. In this manner, the facial recognition system 10 can passively track and identify the individuals 20 for purposes of security access among other reasons. In certain embodiments, appropriate authorities can be alerted of unauthorized entry or passage by certain individuals 20 through the various portions of the facility 12 if image information of such certain individuals 20 is pre-stored in the database 22.

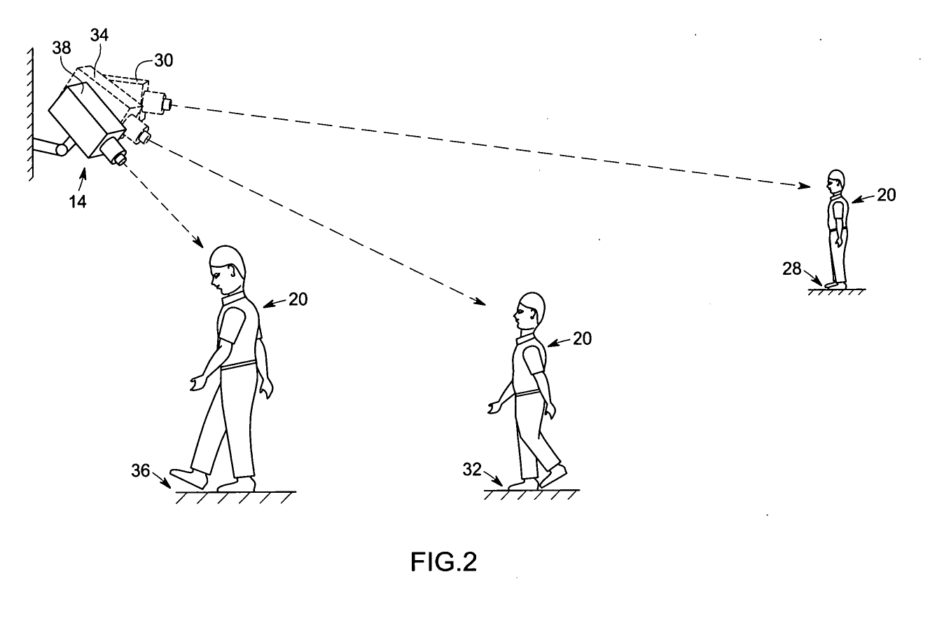

FIG. 2 is a diagrammatical view of an imaging device 14 capturing one or more images of an individual 20 at different locations within the facility 12 of FIG. 1 in accordance with embodiments of the present technique. As illustrated, several images of the individual 20 may be captured by a single imaging device 14 at different focal distances and poses for facial authentication. Similarly, several imaging devices 14 may capture different images of the individual 20. Each time an image is captured, the face recognition system 10 may utilize the captured image during the face recognition process. In certain embodiments, the images captured by the imaging devices 14 may be a continuous video stream or a series of still images. If the imaging devices 14 capture a video stream, then the images may comprise frames at different instances from the video stream. One or more of these frames or still images may include the facial image of the individual 20. Therefore, some or all of these frames or still images may be retained for analysis. At the instant the individual 20 is at the first location or focal distance 28, the imaging device 14 may be at a first angle denoted generally by reference numeral 30. When the individual 20 moves to a second focal distance 32, the imaging device 14 may capture the image of the individual 20 at a second angle denoted generally by reference numeral 34. Similarly, the image of the individual 20 may be captured at a third focal distance 36 at a third angle denoted generally by reference numeral 38. In addition, the individual 20 may have a different facial pose at these different focal distances 28, 32, and 36 and angles 30, 34, and 38. By processing these various images at different orientations, such as focal distances, angles, and poses, the facial recognition system 10 cumulatively improves the facial recognition of the individual 20.

When an individual 20 is enrolled into the facial recognition system 10, a complete model face is formed and stored in the database 22 for that individual 20. During enrollment, one or more facial images of each individual are recorded or acquired by an imaging device 14, for example, a video device such as a still or video camera. In certain embodiments, the recorded facial image is a full three-dimensional facial scan of the individual. For each individual 20 in the databases 22, the system locates and stores a set of ‘k’ fiducial points corresponding to certain facial features, such as the comers of the eyes, the tip of the nose, the outline of the nose, the ends of the lips, beginning and end of the eyebrows, facial outline, and so forth. Each of these k fiducial points has three-dimensional coordinates on the facial image in each captured image of the individual 20. Furthermore, the system may identify and store information on the position of each fiducial point with respect to a reference point, such as a centroid, a lowest point, or a topmost point of the facial image. In addition, the system may store other information associated with each of the k fiducial points. For example, the system may store an intensity value, such as a grayscale value or an RGB (red-green-blue) value corresponding to specific facial features and locations on the image.

In certain embodiments, the set of fiducial points (k) is represented as a vector Vᵢ, which is a one-dimensional matrix of the k fiducial points for the i^{th} image acquired. In one embodiment, the vector Vᵢ is referenced to the centroid of the individual's facial image, where the centroid of the image may be computed by adding all the coordinates of the k fiducial points and dividing by the number of fiducial points (k). For a given vector Vᵢ, a three-dimensional mesh may be plotted based on the k fiducial points represented by the vector Vᵢ. The three-dimensional mesh is created by joining all the fiducial points k in the vector Vᵢ. Therefore, each triangular surface formed by three points in the vector Vᵢ in the three-dimensional mesh, defines a three-dimensional planar patch. Therefore, the three-dimensional mesh defines the three-dimensional appearance or structure of the face based on the plurality of three-dimensional patches. It may be noted that appearance of the face may include the grayscale, RGB, or color values corresponding to each location on the face. Also, each of the three-dimensional planar patches may be associated with a reference point, such as the mid-point of the planar patch, and an average grayscale, RGB, or color value.

Based on these vectors Vᵢ for each individual 20 entered into the database 22, the system cumulatively processes these vectors Vᵢ to create a facial model representative of all individuals 20 in the database 22. By utilizing a suitable generative modeling technique, such as Principal Component Analysis (PCA), a set of vectors Vᵢ is used to create a low-dimensional subspace of independent variables, principal components, or model parameters that define the features of the images. PCA is a statistical method for analysis of factors that reduces the large dimensionality of the data space (observed variables) to a smaller intrinsic dimensionality of feature space (independent variables) that describes the features of the image. In other words, PCA can be utilized to predict the features, remove redundant variants, extract relevant features, compress data, and so forth. For example, the independent variables or model parameters may be defined as X, which is the low-dimensional representation of the plurality of vectors Vᵢ for individuals 20 stored in the database 22. Thus, PCA provides the model parameters X, which define the appearance of the face of the individual 20. These model parameters X are constrained to the features of the face of the individual 20, thereby providing a focused model face. In this manner, a model face is created for all individuals 20 stored in the database 22. When a new face is found, that face can be fitted to the PCA space for generating a feature vector V that allows manipulation of the model face. Other modeling techniques that can be used include Independent Component Analysis, Hierarchical Factor Analysis, Principal Factors Analysis, Confirmatory Factor Analysis, neural networks, and so forth.

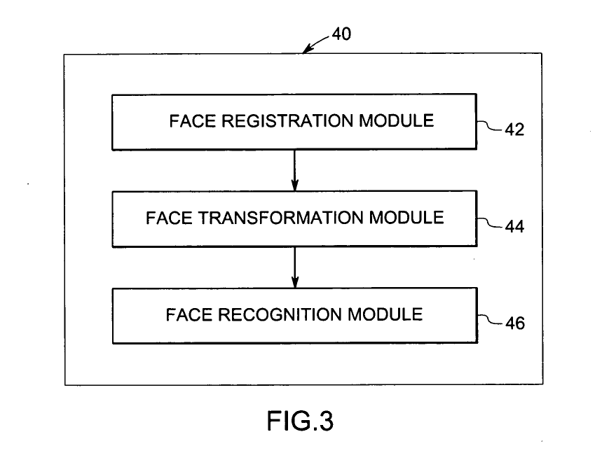

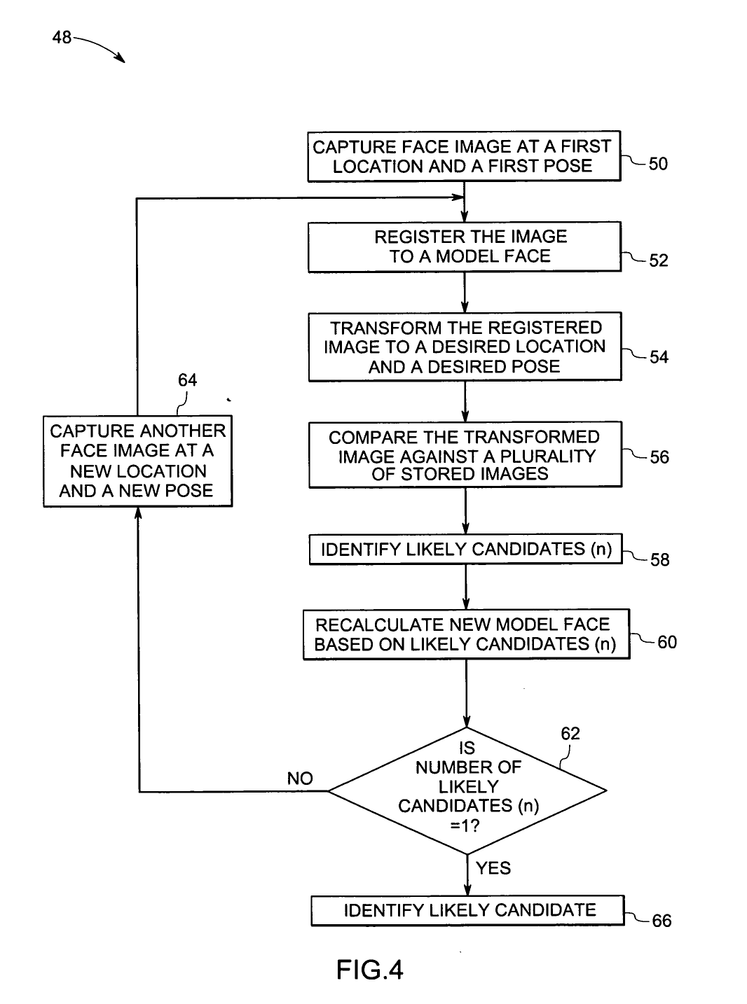

Referring generally to FIG. 3, this figure illustrates a diagrammatic view of an exemplary face recognition system 40 in accordance with embodiments of the present technique. The face recognition system 40 comprises a face registration module 42, a face transformation module 44, and a face recognition module 46. In certain embodiments, the recognition system 40 and its modules 42, 44, and 46 comprise software, hardware, or specific code executable by a suitable processor-based device. The face registration module 42 registers the captured facial image onto a generic or initial model face stored in the database 22. The face transformation module 44 transforms the registered facial image of individual 20 to a desired orientation, for example a desired focal distance and a desired pose, such as a centered frontal view. The face recognition module 46 compares the registered and transformed facial image of individual 20 with the model faces available in the database 22. Functional aspects of each of the modules, which may comprise code stored in the memory 24, will be described in detail with respect to FIG. 4.

FIG. 4 is a flow chart illustrating an exemplary face authentication process 48 of the face recognition system 40 of FIG. 3 in accordance with certain embodiments of the present technique. The face authentication process 48 and its various blocks may comprise software, hardware, or specific code executable by a suitable processor-based device. In the illustrated embodiment, the process 48 begins by capturing a face image at a first location (e.g., first focal distance) and a first pose (block 50). For example, one or more imaging devices 14 may capture a three-dimensional video or one or more still images of individual 20 as the individual 20 approaches, passes, or generally proceeds in the vicinity of the imaging device 14. Thus, the facial image captured by the imaging devices 14 has a particular orientation, e.g., focal distance and pose. In certain embodiments, once an image is captured, the system uses a face detector, such as, for example, a Rowley face detector, to evaluate captured images or video for the presence of a face.

The process 48 then proceeds to register the image to an initial model face (block 52). For example, the process 48 may match positions of certain facial features of the image with corresponding positions on the model face. The process 48 continues by transforming the image to a desired location (e.g., focal distance) and a desired pose (block 54). For example, the process 48 may transform the orientation and geometry of the registered model face from the first focal distance and first pose to the desired focal distance and desired pose, e.g., a centered frontal view of the individual's face. The first focal distance and the first pose may be the focal distance of individual 20 from imaging device 14, and the pose angle of the face of individual 20 with respect to imaging device 14 when the image was captured.

By further example of block 54, the captured facial image of individual 20 may be warped or twisted to produce a synthetic optimal view of the individual's face using the registered model face and the desired focal distance and pose information. Generation of the synthetic optimal view may be facilitated by suitable warping techniques. Warping produces a desired orientation in the synthetic optimal view by mapping pixel locations of the model face to a desired view, such as a frontal view. Transformation may facilitate comparison of the captured facial image with those available in the database. More specifically, the processes of registration and transformation normalize the captured image so that various parameters associated with the captured image become compatible or comparable with the images/models stored in the database 22.

Turning now to block 56 of FIG. 4, the process 48 proceeds by comparing the transformed model face against a plurality of stored model faces. For example, the process 48 may input the synthetic optimal view or the transformed model of the individual's face into the face recognition module 46 for comparison with the stored model faces in the database 22. Comparison of the images/models may be carried out by a suitable face comparison module or comparison engine, such as eigenface method or template-matching approaches. Based on these comparisons in block 56, the process 48 then continues by identifying a number of likely candidates (n) that may be the individual 20 captured in the image (block 58). The process 48 creates a new model face based on the set of identified likely candidates (n) and the transformed model face (block 60). More specifically, the PCA space is re-calculated based on the 3D datasets (and associated V vectors) captured at enrollment associated with the most likely candidates (n). Therefore, block 60 of the process 48 reduces the number of datasets and, thus, the size of the PCA space. The number of likely candidates (n) is then checked for convergence to a single candidate (block 62).

If the number of likely candidates (n) is not one at block 62, an optional new image of the individual 20 may be captured and utilized for further processing (block 64). Based on the new model face and optional facial image, the process 48 repeats the acts of registering the image to the new model face at block 52, transforming the registered image to the new model face at block 54, comparing the transformed image against the stored images at block 56 (e.g., stored images of the likely candidates (n) from the previous iteration of process 48), and identifying a new number of likely candidates (n) at block 58. The process 48 continues by creating another new model face based on the new number of likely candidates (n) (block 60). Preferably, the new number of likely candidates (n) is less than the previous number of likely candidates (n). Again, if the new number of likely candidates (n) is not equal to one, then the process 48 optionally proceeds by acquiring another new face image. In turn, the process 48 repeats the acts of registering, transforming, comparing, and identifying at blocks 52, 54, 56, 58, and 60 respectively.

This iterative and cumulate improvement of the model face and reduction of the number of likely candidates (n) continues until a single likely candidate is identified at block 66. In each iteration, the process 48 improves the model face based on a smaller number of likely candidates (n), which have facial features closer to those of the individual 20 actually having the captured face. In other words, each iteration of the process 48 eliminates unlikely candidates and focuses the model face on the most likely candidates (n), thereby making the model face resemble the individual 20 more accurately. As a result of this improvement, the comparison (block 56) between the model face and the number of likely candidates eliminates more unlikely candidates who no longer resemble the model face. Eventually, the process 48 converges onto the single likely candidate (n=1) at block 66.

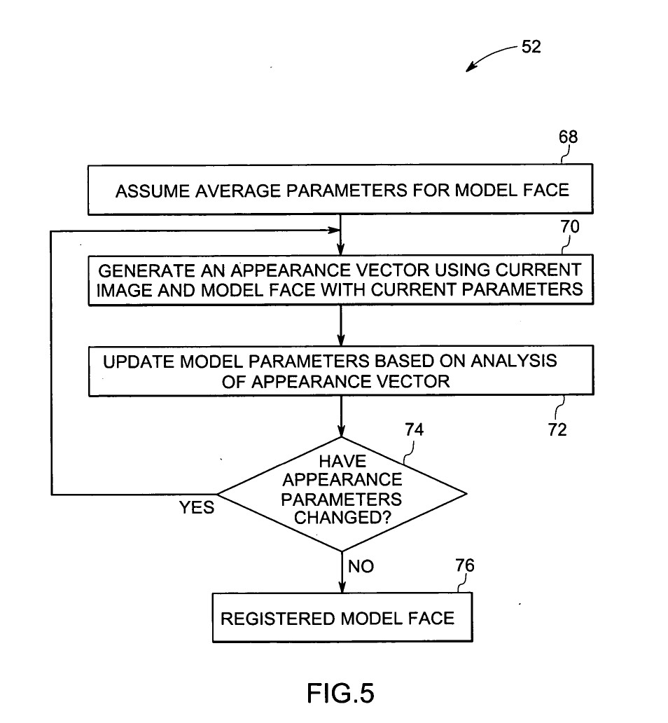

Turning now to FIG. 5, this figure is a flow chart illustrating an exemplary embodiment of the face registration process 52 of the face authentication process 48 in FIG. 4 in accordance with certain aspects of the present technique. At block 68, the process 52 begins by assuming average parameters, which are computed as the mean values for X based on the facial images of the individuals 20 in the database 22. In an initial iteration of the face authentication process 48 discussed above with reference to FIG. 4, these parameters would correspond to the entire set of Vᵢ vectors for individuals 20 stored in the database 22. In subsequent iterations, the parameters would correspond to a progressively smaller set of likely candidates (n). It may be noted that if no images were present in the database 22, the average parameters would represent the X for the individual 20 being analyzed. The parameters of the initial model face may include a desired focal distance and a desired pose (e.g., a frontal pose) with respect to the imaging device.

After assuming the average parameters at block 68, the process 52 continues by generating an appearance vector using the current image and the model face with current parameters (block 70). In other words, the captured facial image is fitted onto the initial model face by adjusting the model parameters X to provide the appearance vector. The process 52 then proceeds by updating the model parameters based on an analysis of the appearance vector (block 72). The model face, which is parameterized on X, is effectively a generative structural model. For a given set of values, the three-dimensional structure of the face can be synthesized. Once a three-dimensional structure of the face is generated, the frontal view of the individual 20 in a normalized coordinate system is computed.

The process 52 then proceeds by evaluating whether the parameters have changed or are different from the model face for the appearance vector (block 74). In one embodiment, a residual function may be defined that is minimal for desired values of X. The residual function may be generated by computing Euclidean distance between the appearance vectors based on the appearance model. In a different embodiment, a PCA space for normalized frontal views is computed. The synthesized frontal view is then projected onto the appearance model based on X. The difference between the projected synthesized frontal view and the synthesized frontal view are the residuals. These will be small for desirable values of X. In other words, if a set of V vectors that are used to generate the model space for X, are restricted, the freedom of X also is restricted, which facilitates a more constrained and accurate fitting process. For example, the appearance vector of the updated model face is compared with the appearance vector of the captured face image. If the parameters are different, then the process 52 continues by repeating the acts of generating the appearance vector at block 70 and updating the model parameters at block 72 until there is no difference between the parameters of the model face and the captured facial image. When no differences remain, the process 52 has successively registered the captured image with the model face to produce a registered model face or a registered image 76.

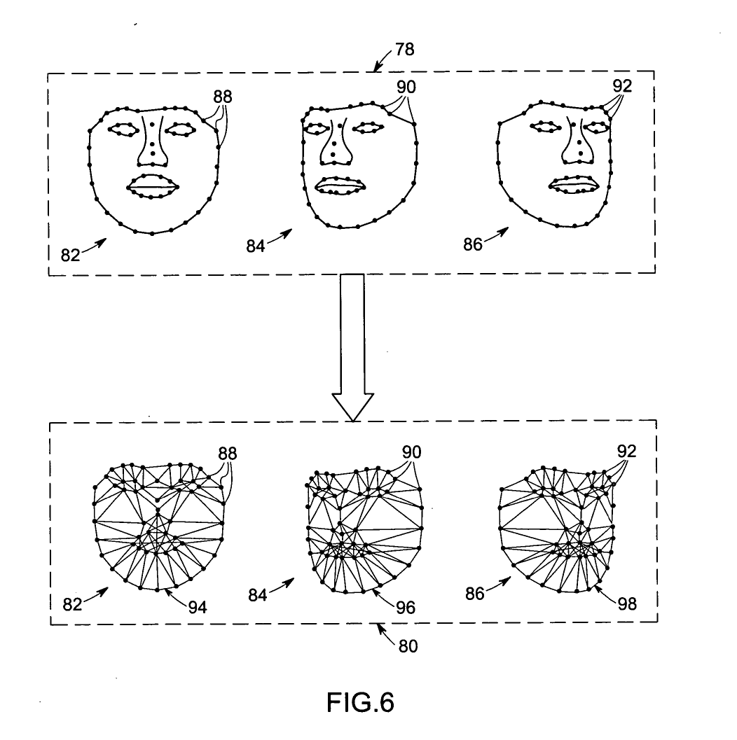

Referring now to FIG. 6, the face registration process 52 of FIGS. 4 and 5 is diagrammatically illustrated by two sets of images 78 and 80 in accordance with embodiments of the present technique. The first set 78 includes three-dimensional facial images having a frontal pose 82, a leftward pose 84, and a rightward pose 86 of the individual 20 captured by the imaging device 14. FIG. 6 also illustrates a set of fiducial points 88, 90, and 92 registered to facial features (e.g., eyes, nose, lips, facial outline, etc.) on the respective images 82, 84, and 86. Each of these fiducial points 88, 90, and 92 has a three-dimensional coordinate relative to a desired reference coordinate, such as the center of the facial image. In certain embodiments, the system provides a vector V for each of the images 82, 84, and 86, wherein each vector V includes all three-dimensional coordinates of the fiducial points 88, 90, and 92, respectively. In the second set 80, each set of fiducial points 88, 90, and 92 is joined together to form a three-dimensional mesh 94, 96, and 98 corresponding to the facial images 82, 84, and 86, respectively. As illustrated, these three-dimensional meshes 94, 96, and 98 represent registered model faces of the captured facial images 82, 84, and 86, respectively. Based on these fiducial points 88, 90, and 92 and the corresponding three-dimensional meshes 94, 96, and 98, the face authentication process 48 of FIG. 4 can transform the meshes 94, 96, and 98 to a common orientation to perform facial recognition.

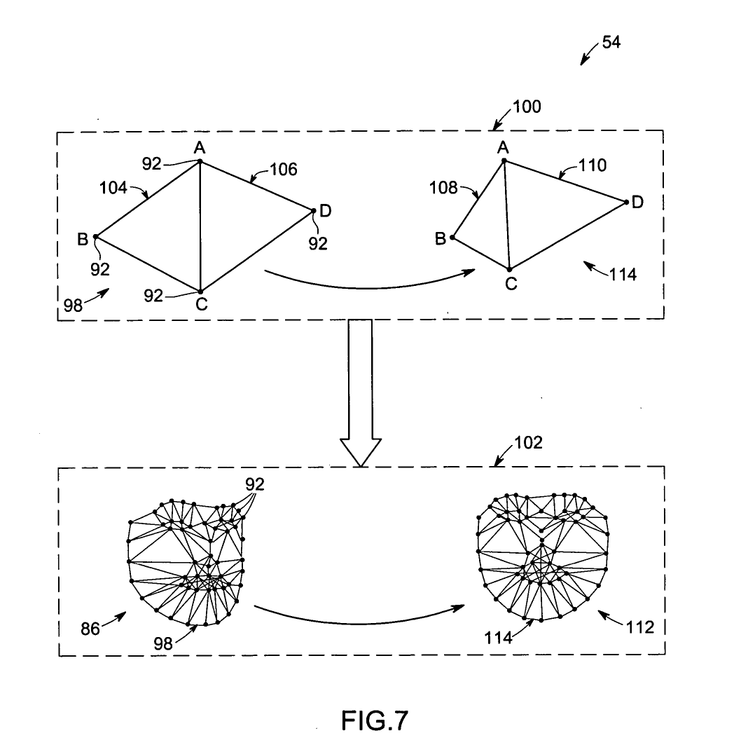

FIG. 7 diagrammatically illustrates the face transformation process 54 of the face authentication process 48 in FIG. 4 in accordance with one aspect of the present technique. As illustrated in dashed blocks 100 and 102, the face transformation process 54 involves sectional analysis and warping of the three-dimensional meshes or models of captured images. For example, the three-dimensional model or mesh 98 in the left side of dashed block 102 corresponds to the rightward pose 86 of facial images 78 in FIG. 6. In the left side of dashed block 100, two three-dimensional planar patches or triangular sections 104 and 106 of the three-dimensional model or mesh 98 are illustrated for an exemplary transformation step of the process 54. These triangular sections 104 and 106 are each linked together by a number of fiducial points 92 (e.g., A, B, C and D) in the three-dimensional model or mesh 98. In operation, the face transformation process 54 warps the original rightward pose image 86 section by section to provide a desired orientation, e.g., frontal pose at desired focal distance. Accordingly, when the three-dimensional planar patches or triangular portions 104 and 106 are transformed from an initial focal distance and pose to the desired focal distance and pose, the triangular portions 104 and 106 acquire transformed shapes 108 and 110 as illustrated in the right side of dashed block 100. The face transformation process 54 continues to modify the mesh 98 section by section until the entire mesh 98 has been transformed into a transformed image or synthetic face 112 at the desired orientation (e.g., frontal pose at the desired focal distance), as illustrated in the right side of dashed block 102. Again, this synthetic face 112 is represented by a transformed three-dimensional mesh or model 114 of the rightward pose image 86 of the individual 20 captured on the imaging device. Based on this synthetic face 112, the face authentication process 48 of FIG. 4 can more accurately perform face recognition using a desired face recognition system.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A method of face recognition, comprising:
capturing an image including a face;
registering features of the image to fit with a model face to generate a registered model face;
transforming the registered model face to a desired orientation to generate a transformed model face; and
comparing the transformed model face against a plurality of stored images to identify a number of likely candidates for the face.

2. The method of claim 1, comprising:
creating a new model face based on the number of likely candidates;
capturing a new image including the face;
registering features of the new image to fit with the new model face to generate a new registered model face;
transforming the new registered model face to the desired orientation to generate a new transformed model face; and
comparing the new transformed model face against a stored image of each of the number of likely candidates to identify a new number of likely candidates for the face.

3. The method of claim 2, comprising:
updating the number of likely candidates to be the new number of likely candidates; and
repeating said creating, capturing, registering, transforming, comparing, and updating until a single likely candidate is identified as having the face.

4. The method of claim 3, wherein repeating comprises cumulatively adding facial data to improve accuracy of the new transformed model face.

5. The method of claim 2, wherein creating the new model face comprises providing the new model face based on the transformed model face.

6. The method of claim 1, wherein capturing the image comprises acquiring a three-dimensional image of the face at an orientation.

7. The method of claim 6, wherein acquiring the three-dimensional image comprises passively acquiring a video stream.

8. The method of claim 6, wherein acquiring the three-dimensional image comprises passively acquiring a still image.

9. The method of claim 1, wherein capturing the image comprises passively tracking movement of an individual having the face.

10. The method of claim 1, wherein registering comprises fitting the features of the image with a plurality of three-dimensional points of the model face.

11. A face recognition system, comprising:
a face registration module operable to process a captured facial image having a facial orientation and to fit the captured facial image with a model face to generate a registered model face;
a face transformation module operable to transform the registered model face from the facial orientation to a desired orientation to generate a transformed model face; and
a face recognition module operable to compare the transformed model face with a plurality of stored images of individuals to identify at least one likely candidate for the captured facial image.

12. The face recognition system of claim 11, wherein the face registration module is operable to generate a plurality of fiducial points on the captured facial image.

13. The face recognition system of claim 12, wherein the captured image is acquired by one of a plurality of cameras disposed at a location, wherein each of the plurality of cameras is operable to passively acquire images of an individual moving about the location.

14. The face recognition system of claim 11, wherein the face registration module is operable to process a new captured facial image having a new facial orientation and to fit the new captured facial image with a new model face to generate a new registered model face, wherein the new model face is developed based on the at least one likely candidate.

15. The face recognition system of claim 14, wherein the face transformation module is operable to transform the new registered model face from the new facial orientation to the desired orientation to generate a new transformed model face.

16. A surveillance system configured to identify a person, comprising:
a plurality of imaging devices, wherein each of the plurality of imaging devices is operable to capture at least one image, including a face of the person to generate a captured image;
a face registration module operable to fit the captured image to a model face to generate a registered model face;
a face transformation module operable to transform the registered model face into a transformed model face having a desired orientation; and
a face recognition module operable to identify at least one likely candidate from a plurality of stored images based on the transformed model face.

17. The surveillance system of claim 16, wherein the model face is iteratively updated based on the at least one likely candidate and the transformed model face until the person is identified.

18. The surveillance system of claim 16, wherein the plurality of imaging devices is operable to capture the at least one image without active participation from the person.

19. The surveillance system of claim 16, wherein the plurality of imaging devices is wirelessly coupled to a monitoring station that stores the plurality of stored images.

20. A method of providing security, comprising
providing imaging devices in a plurality of areas through which individuals pass, wherein the imaging devices are operable to obtain facial images of each of the individuals;
providing a face recognition system operable to recognize an individual having the facial images by iteratively and cumulatively identifying candidates for each of the facial images.

21. The method of claim 20, wherein providing the face recognition system comprises providing a face transformation system to transform orientations of the facial images into a desired orientation for facial recognition.
